(19) United States
(12) Patent Application Publication
(10) Pub. No.: US 2002/0105687 A1
(43) Pub. Date: Aug. 8, 2002

(54) Apparatus and method for controlling a scanner

(76) Inventor: Chun-Liang Lin, Hsinchu (TW)

Correspondence Address: J.C. Patents, Inc., Suite 114, 1340 Reynolds Ave., Irvine, CA, 92614, US

(21) Appl. No.: 09/779,399

(22) Filed: Feb. 8, 2001

(51) Int. Cl. H04N 1/46

(52) U.S. Cl. 358/505; 358/514

(57) ABSTRACT

An apparatus and method of a scan controller for multi-sets of motors and sensors. The apparatus comprises a plurality of shift registers, a plurality of latch registers and a plurality of multiplexes. The shift registers are used to receive and transmit data. The latch registers are used to maintain data corresponding to the outputs of shift registers. The multiplexes are installed between the motor control data and sensors data to select the data of the shift registers.

### BACKGROUND OF THE INVENTION

1. Field of Invention

The present invention relates generally to an apparatus and method for controlling a scanner. More particularly, the present invention relates to an apparatus and method for controlling multi-sets of motors and sensors in a scanner.

2. Description of the Related Art

In general, a scanner uses a moving image sensor to scan documents. For example, a charge coupled device (CCD) or a contact image sensor (CIS) scans the document that is placed on a scanner. A motor is therefore required to operate the image sensor. Some of the scanners have an upper transparence, wherein a light tube is installed in the upper transparence to improve the scan process. Under this condition, a motor is required to operate the light tube. If an automatic document feeder (ADF) is installed, the device also requires a motor to operate the ADF. Therefore, according to above, there will be at least one motor that is installed in the scanner.

Apart from the motor, there are all kinds of sensors to detect the state of the scan. Detecting coefficients are provided from those sensors to the processor. The processor then operates according to those detecting coefficients. For example, a sensor of the ADF will detect the existence of papers. There is a sensor at a region of the light tube or the image sensor to detect a location or a movement state of these apparatuses.

According to the above, many sets of motors and sensors are generally installed in a scanner. In the conventional method, a system is used to control the motor control data of multi-sets of motors (these motors are in series or parallel) separately from the sensor data that are detected by the multi-sets of sensors. Therefore signals required for the motors and sensors are different, and the number of transmission lines is thus increased. As a result the system of the device becomes complex and the cost increases.

### SUMMARY OF THE INVENTION

The present invention provides an apparatus and method of a scan controller for multi-sets of motors and sensors. The device of the present invention uses a multiplex to select the input data of the motor control data and the input data of the sensor data. Therefore multi-sets of motors and sensors can use a common line to receive or transmit data that is required. The circuit of the scan controller can be simplified and the cost can also be reduced.

The present invention provides an apparatus of a scanner for multi-sets of motors and sensors. The scanner comprises a plurality of shift registers, a plurality of latch registers and a plurality of multiplexes. The shift registers receive and transmit data. The latch registers maintain data corresponding to the outputs of shift registers. The multiplexes are installed between the motor control data and the sensor data to select the data of the shift registers.

The present invention provides a method of a scanner for multi-sets of motors and sensors. The steps of the method comprise: transmitting at least one of motor control data from a register, wherein the motor control data drives the corresponding motor; and transmitting at least one of the sensor data to those inputs of the registers and then transmitting out those sensor data. The method of driving the corresponding motor transmits the motor control data to the corresponding motor when a detecting-data signal is produced. The sensor data are also stored in the registers when the detecting-data signal is produced.

According to the above, the present invention uses the same set of registers to store the motor control data or the sensor data, and the multiplex selects the input data. A common line is used by multi-sets of motors and sensors to transmit and receive the required data.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is an apparatus structure of multi-sets of motors and sensors according to a preferred embodiment of the present invention; and

FIG. 2 is a diagram of a signal transmission according to a preferred embodiment of the invention.

### DESCRIPTION OF THE PREFERRED EMBODIMENTS

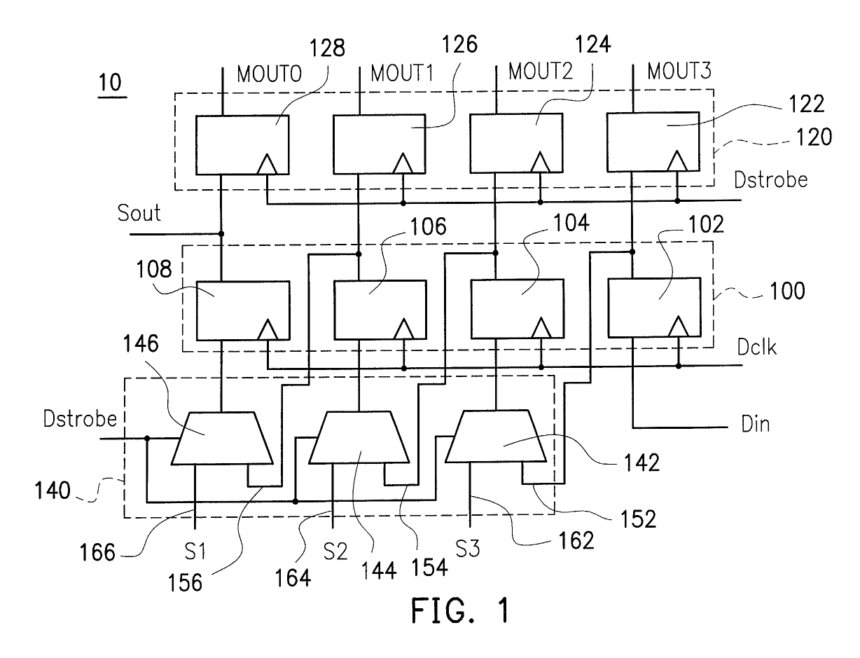

FIG. 1 is an apparatus structure of multi-sets of motors and sensors according to a preferred embodiment of the present invention. The scan controller of multi-sets of motor and sensors 10 comprises a set of shift registers 100, a set of latch registers 120 and a set of multiplexes 140. The set of shift registers 100 of the invention comprises a plurality of shift registers 102, 104, 106 and 108. The set of latch registers 120 comprises a plurality of latch registers 122, 124, 126 and 128. The set of multiplexes 140 comprises a plurality of multiplexes 142, 144 and 146. There can be a flip-flop device among the shift registers 102, 104, 106 and 108, but the invention is not limited to only a flip-flop device.

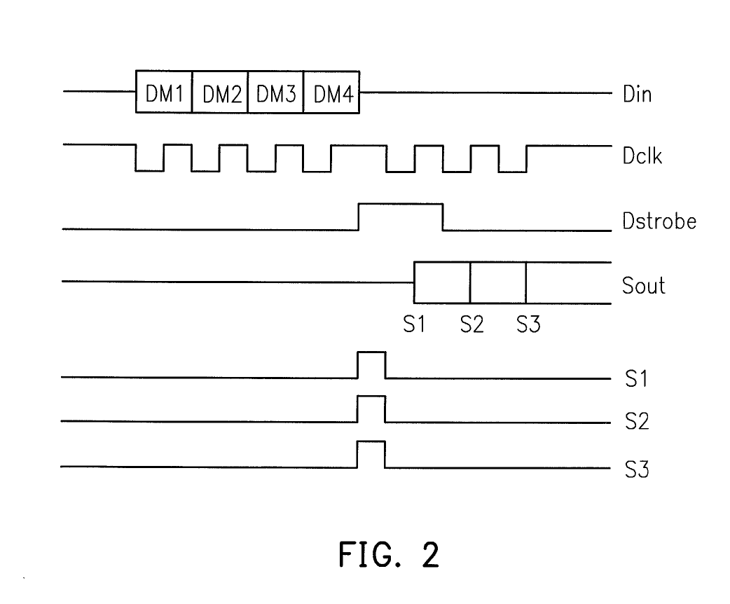

FIG. 2 is a diagram of the signals according to a preferred embodiment of the invention. The motor control data DM1 that are used to control the motor are transmitted from signal line Din to the shift register 102. According to the changing of the Dclk signal ,(in the preferred embodiment of the invention, the Dclk is a rising edge trigger), the motor control data will sometime be transmitted to the latch register 122 to store when the Dclk signal is triggered. At the sometime, the motor control data DM1 will also be transmitted to the multiplex 142. One important aspect of the preferred embodiment of the invention is the output data from the multiplexes 140 is selected by a signal Dstrobe. When the signal Dstrobe is in a low level, the output data from multiplexes 142, 144 and 146 are respectively to the input data of 152, 154 and 156. When the signal Dstrobe is in a high level, the output data from multiplexes 142,144 and 146 are respectively to input data 162, 164 and 166.

When the Destrobe is in a low level, a motor control signal DM1 that is transmitted to the multiplex 142 will be transmitted to the shift register 104. A motor control data DM2 will be transmitted from the signal line Din to the shift register 102. Similar, when a next signal Dclk is triggered, the motor control data DM1 will be transmitted to the latch register 124 and the shift register 106. The motor control data DM2 will be transmitted to the latch register 122 and the shift register 104. This process will repeating proceed until the motor control data DM1, DM2, DM3 and DM4 are transmitted respectively to the latch registers 128, 126, 124 and 122. The signal Dstrobe will change from a low level to a high level to trigger the latch register 120.

The motor control data DM1, DM2, DM3 and DM4 in the latch register 128, 126, 124 and 122 will be transmitted out respectively from the output MOUT0, MOUT1, MOUT2 and MOUT3 to the motor control circuit. (not show in the drawings).

When the motor control data is transmitted out, the sensor data S1, S2 and S3 that are obtained from multiplexes will be transmitted respectively to the multiplex 146, 144 and 142. Another important aspect of the present invention is the sensor data S1, S2 and S3 are transmitted at the same time but the present invention is not limit to transmitting all the data at the same time. It is because the signal Dstrobe is still in a high level, the data that are transmitted respectively to the inputs of the 162, 164 and 166 will be transmitted out from the multiplex 142, 144 and 146. Therefore the sensor data S1, S2, and S3 will then be transmitted to the shift register 108, 106 and 104. Afterward, when the signal Dclk is triggered, the sensor data S1 can be transmitted from the shift register. The sensor S1 can be continuously transmitted out from the signal line Sout. The sensor data S2 and S3 are transmitted respectively to the input 156 and 154.

When the signal Dstrobe is in low level, the Multiplex 146, 144 and 142 will transmit out the data that are transmitted in from the inputs of 156, 154 and 152. Therefore, sensor data S2 and S3 will be transmitted out through the signal line Sout according the mentioned method.

The drawings according to the preferred embodiment of the present invention comprises a set of latch registers, a set of shift register and a set of multiplexes. Although the drawings contain certain number of the components, the present invention is not limited to the quantity of the devices that are installed. The number of the devices used in the preferred embodiment is to explain the invention easily, but it does not mean the apparatus of the invention can only be setup according to the drawings.

According to above, the advantage of the present invention is the multi-sets of motors and sensors can transmit and receive signals from a common line, the cost of circuit can be reduced and the design becomes simple. The cost is thus reduced.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for controlling a scanner, wherein the scanner includes a plurality of motors and sensors, the apparatus comprising:
a set of multiplexes connected to the sensors for receiving a sensor data from the sensors;
a set of shift registers connected respectively to output of each corresponding multiplexes;
a set of motors connected respectively to the set of the shift registers, wherein the set of shift registers received a motor control data, and the motor control data is feedback from the shift registers to the multiplexes; and
a set of latch registers connected respectively to the set of shift registers for latching the output data from the shift registers;

2. The apparatus of claim 1, wherein the shift register is a flip-flop device.

3. The apparatus of claim 1, wherein the latch register further outputs the latched data to the respective motor.

4. A method of controlling a scanner, the scanner having a set of motors and having a set of sensors, the method comprising:
receiving a motor control data from a plurality of registers;
driving the corresponding motor according to the motor control data;
receiving a sensor data from the registers by a set of shift registers, wherein the motor control data is feedback to a set of multiplexes;
selecting one of data from the sensor data or the motor control data in the multiplexes;
transmitting the selected data to the corresponding shift registers, wherein the selected data is transmitted to the latch registers;
latching the selected data in the latch registers;
transmitting the latched data to the corresponding sensors to control the corresponding motors.

5. The method of claim 4, wherein the corresponding motors is controlled when a data-detecting signal is produced, the motor control data are transmitted to the multiplexes.

6. The method of claim 5, wherein the data-detecting signal is produced when the sensor data are transmitted to registers.
